(19) United States
(12) Patent Application Publication
(10) Pub. No.: US 2010/0083780 A1
(43) Pub. Date: Apr. 8, 2010

(54) ONE PIECE RING GEAR-PARK BRAKE DRUM

(76) Inventors: Joseph Szuba, Dearbom, MI (US); Rodney G. Whitbeck, Northville, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/245,065

(22) Filed: Oct. 3, 2008

(51) Int. Cl. F16H 57/10

(52) U.S. Cl. 74/411.5

(57) ABSTRACT

A component for transmitting torque between a gear unit and a shaft includes a ring gear portion, a park brake drum portion formed integrally with the ring gear portion, a disc portion formed integrally with the park brake drum portion, and a hub portion formed integrally with the disc portion.

### BACKGROUND OF THE INVENTION

1. Field of the Invention

This invention relates generally to metal forming and, in particular, to an integrated ring gear-parking brake drum produced in one piece from a cold-formed preform. Helical gear teeth are formed on a ring gear portion of the product and spline teeth on a hub portion.

2. Description of the Prior Art

The kinematic arrangement of an automatic transmission for a rear wheel drive motor vehicle may include a Ravigneaux gearset, whose components include two sun gears, a ring gear surrounding the sun gears and two sets of planetary pinions. The pinions of a first set mesh with a first sun gear and the ring gear, the pinions of the second set mesh with a second sun gear and the pinions of the first set. The transmission output torque is carried by the ring gear, transmitted axially by a parking drum to a radial disc and transmitted radially to a sleeve or hub, which is connected by a spline to the transmission output shaft and is connected to the radial member.

The ring gear is formed with internal, helical gear teeth. The parking drum is formed with external spline teeth, which are engaged by a park pawl, secured to the transmission case for preventing the vehicle from moving inadvertently when the wheel brakes are disengaged.

According to a current manufacturing process the ring gear, the park brake drum, and the radial disc and its hub are formed as separate components, each produced to precision dimensions. The helical ring gear is laser welded to the park brake drum. The output shaft hub-radial disc is attached to the park brake drum using a spline and snap ring.

The park brake drum, output shaft hub and radial disc are formed extensively to carry principally torsion load in the application. Each component is machined to tight tolerance. The ring gear, however, cannot be machined directly into the parking drum because the ring gear must be broached, requiring a long broach bar to pass completely through the ring gear.

A need exists in the industry for this combination of separate components to be formed integrally, i.e., in one component without need for bonding, welding or mechanical connections among the components, yet providing a mechanical connection to a transmission shaft.

### SUMMARY OF THE INVENTION

A component for transmitting torque between a gear unit and a shaft includes a ring gear portion, a park brake drum portion formed integrally with the ring gear portion, a disc portion formed integrally with the park brake drum portion, and a hub portion formed integrally with the disc portion.

The one-piece ring gear-park brake drum is produced at lower cost than the multiple-piece assembly and requires no mechanical connections, welds or bonded connections. Complexity during assembly is greatly reduced compared to the three -piece assembly. Warranty costs are reduced due to few parts and no inter-part connections, which reduce opportunity for in-service component failure. The component is inherently more rigid, lighter and better balanced than a multi-piece assembly.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram showing a series of process steps for making a perform cylinder;

FIG. 2 is side view of the contour of the preform of FIG. 1 being formed by flow forming;

FIG. 3 is a perspective view of a circular cylinder having been cold formed from the cupped preform of FIG. 1;

FIG. 4 is a perspective view of a cylindrical blank cut from the cylinder of FIG. 3;

FIGS. 5A-5D are cross sections illustrating steps in the process of forming a ring gear and clutch race;

FIG. 6 is a cross section illustrating the ring gear and clutch race of FIGS. 5A-5D before being cut into lengths;

FIG. 7 is a front view of an outer race for a one-way clutch;

FIG. 8 is a perspective view of a ring gear having internal helical gear teeth;

FIG. 9 is a perspective view of a series of segments having been cold formed and cut from a perform cylinder and ready for forming into clutch races;

FIG. 10 is a perspective view of a series of segments having been cold formed and cut from a perform cylinder and ready for forming into ring gears;

FIG. 11 is a side view of a Ravigneaux gearset for an automatic transmission that includes an integrated ring gear-park brake drum formed in one piece;

FIGS. 12A-12D are cross sections illustrating steps in the process of forming the ring gear-park brake drum of FIG. 11;

FIG. 13 is a perspective view of the integrated ring gear-park brake drum of FIG. 11; and

FIG. 14 is a perspective view of the integrated ring gear-park brake drum of FIG. 11.

### DESCRIPTION OF THE PREFERRED EMBODIMENT

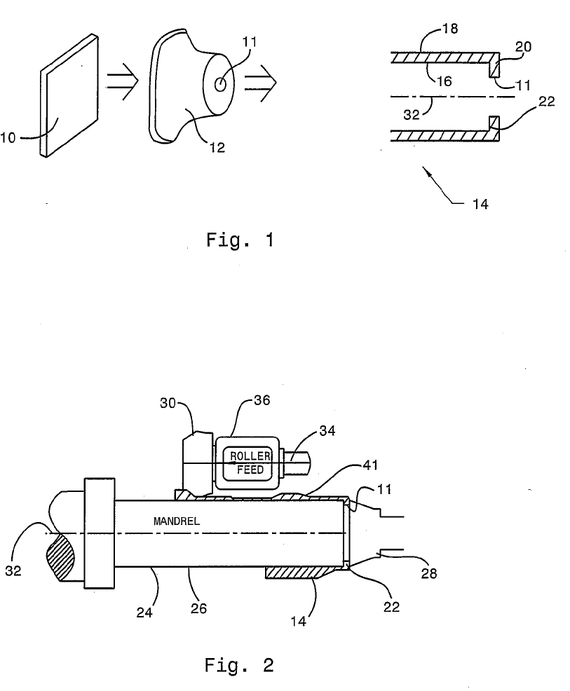

Referring now to the drawings, FIG. 1 illustrates a workpiece 10, preferably a plate or coiled sheet of carbon steel, which is formed with a central hole 11 into an elongated cup shape 12 by a conventional cold or hot forging or drawing method. After the cupped preform 12 is annealed to soften the material, make it less brittle and relieve internal stresses, the cup shaped preform 12 is processed by various techniques including a flow forming operation to produce a net shape preform 14 having an inner surface 16, an outer surface 18 and an end 20 that is partially closed by a radial flange 22.

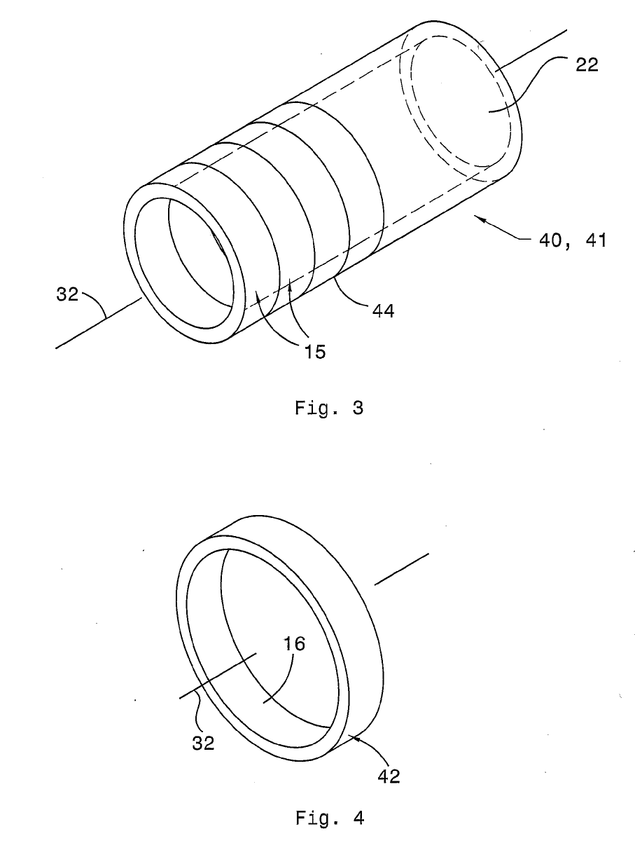

The flow forming procedure illustrated in FIG. 2 employs a mandrel 24 having an exterior surface 26. The net shape preform 14 is fitted over the mandrel and secured at its end 20 by a tailstock 28 that clamps flange 22 to the end of the mandrel. Several rollers 30, mutually spaced angularly about axis 32, are forced into contact with the outer surface of preform 14. Each roller 30 rotates about a respective axis 34 and translates along axis 32 toward the open end of the perform cylinder.

The outer surface 18 of preform 14 is flow formed into a cylinder 40 by contact pressure between preform 14 and the rollers 30 and movement of the rollers over the mandrel 24 and preform. The inner surface 16 of preform 14 is flow formed due to contact pressure between preform 14 and the outer surface of the mandrel 24. The material of the cylindrical wall of the preform 14 flows axially and radially with respect to axis 32, as the rollers 30 and roller feed 36 move as a unit along axis 32 and angularly and radially with respect to the axis.

Alternately, the outer surface 18 of preform 14 is not a uniform circular cylinder but instead is a cylinder 41 formed with exterior features, such as changes in its wall thickness due to the material of the cylindrical wall of the preform flowing axially and radially with respect to axis 32 as the rollers 30 move both axially about axis 32 and radially with respect to axis 32, as FIG. 2 shows above the axis 32.

Similarly, the outer surface 26 of the mandrel 24 may be other than a circular cylinder. For example, the outer surface 26 of the mandrel 24 may be formed with gear teeth extending along at least a portion of the length the length of the mandrel, or the outer surface of the mandrel 24 may be formed with cam ramps for the outer race of a one-way clutch, the cam ramps being arranged about axis 32 and extending along at least a portion of the length of the mandrel. In these instances, the inner surface 16 of the perform cylinder 14 will be flow formed either with helical gear teeth or cam ramps.

As FIG. 4 illustrates, the flow formed cylinder 40, 41 is then cut transversely with respect to axis 32 into multiple ring segments or blanks 42 by any of several techniques including laser cutting. Preferably, cylinder 40, 41 is cut into segments 42 by a concentrated jet of water at high pressurize, preferably containing garnet, directed from a nozzle 44 onto the rotating cylinder at axially spaced locations. The segments 42 are thereafter finish machined, thermally processed and coated.

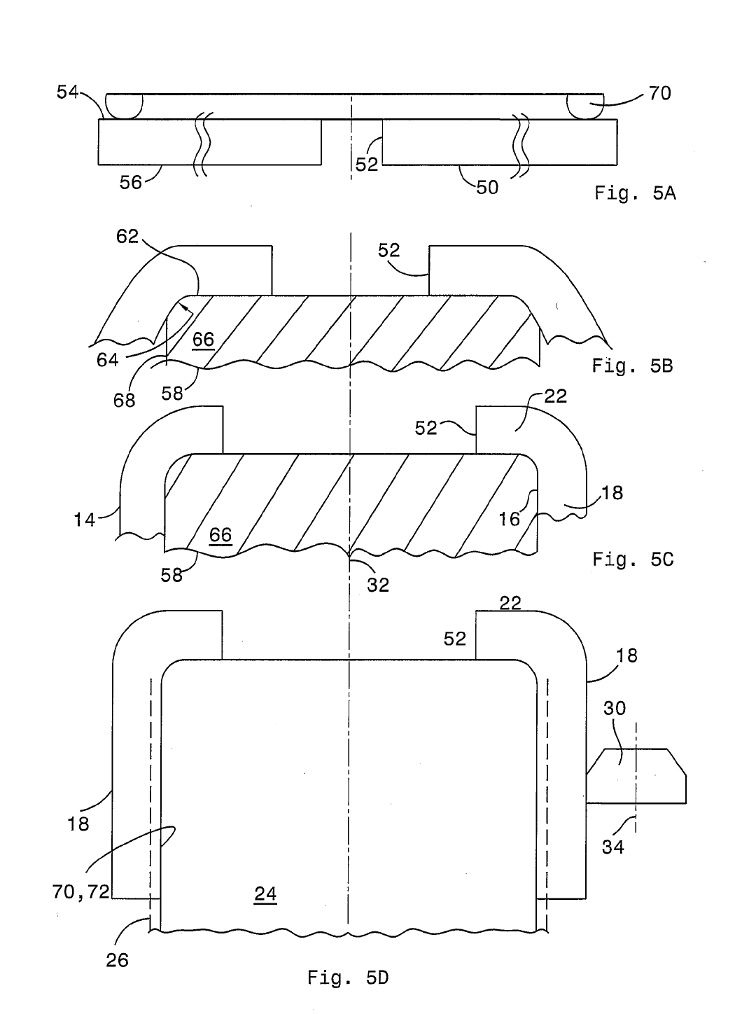

An alternate process for forming a preform cylinder, called in-die forming, is described with reference to FIGS. 5A-5D. A circular plate or sheet 50 having a central pilot hole 52, preferably of very low-carbon steel, is stamped with a diameter of about 1.0 inch. Plate 50 has an upper surface 54 and a lower surface 56. If plate 50 is of high carbon steel, it is annealed before executing the progressive forming stages.

Plate 50 is placed over a solid die 58 centered about axis 32. Die 58 includes a shoulder 62 having an internal radius 64, and a body 66 having an outer surface 68. A draw ring 70 contacting the upper surface 54 of plate 50 is forced by a hydraulic press (not shown) downward in several progressive stages causing the plate to conform to the surface of shoulder 62, radius 64 and surface 68.

As FIG. 5C shows, as draw ring 70 moves downward along axis 32, the diameter of hole 52 increases, and radial flange 22 is formed with the desired length and the preform plate SO is forced to conform to the shape of the outer surface 68 of die 58 due to contract pressure between the die and the plate as draw ring 70 is forced over the perform plate.

When plate 50 is formed into the shape of the preform cylinder 14 shown below axis 32 in FIG. 2, die 58 is removed from the preform cylinder and is replaced by mandrel 24. The tailstock 28 is used to clamp flange 22 to the axial end of the mandrel 24. Then rollers 30 are forced into contact with the outer surface 18 of preform 14. Each roller 30 rotates about a respective axis 34 and translates along axis 32.

The outer surface of preform 14 is flow formed by contact pressure between preform cylinder 14 and rollers 30 and by movement of the rollers over the mandrel 24 and the preform. The inner surface of preform cylinder 14 is flow formed due to contact pressure, which forces the preform into contact with the outer surface 68 of mandrel 24. The material of the cylindrical wall of the preform 14 flows axially and radially with respect to axis 32 as the rollers 30 move axially along the axis 32, circumferentially about the axis and radially with respect to the axis.

Preferably, the outer surface 26 of the mandrel 24 is formed with a circular cylinder 71, splines or gear teeth 72 for a planetary gearset of an automatic transmission, or cam ramps 73, such as those that are formed on the inner surface of a one-way clutch race. As flow forming step is performed, the perform 14 attains the shape of cylinder 40, 41 and the inner surface of perform 14 conforms to the shape on the outer surface 68 of mandrel 24. In this way either certain gear teeth, splines 72, cam ramps 73 or a circular cylinder 21 are flow formed on the outer surface 68 of mandrel 24.

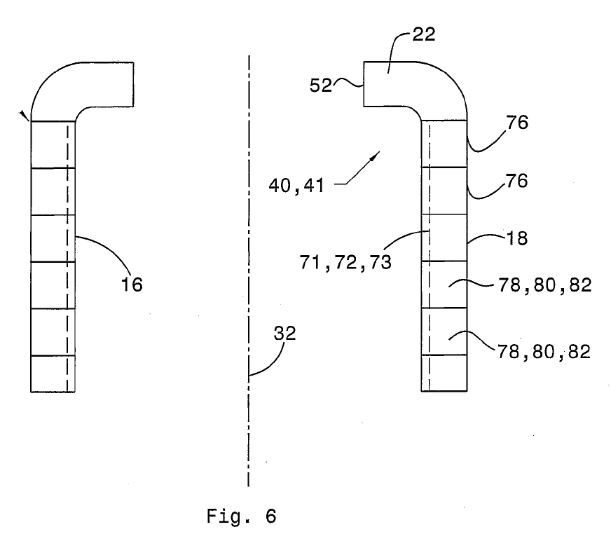

After the flow forming step is executed, the flow formed cylinder 40, 41 will have the shape illustrated in FIG. 6. The internal surface 16 is carburized and induction heated. Next, the outer surface of cylinder 40, 41 is ground to its final shape.

The flow formed cylinder 40, 41 is then cut transversely with respect to axis 32 into multiple segments or ring blanks 76 using either a laser cutting technique or a concentrated jet of pressurized water, as described with reference to FIGS. 3 and 4. The segments 76 will have the form of a right circular cylindrical ring 78, or a ring gear 80 or a race 82 of a one-way clutch, depending on the form of the outer surface 26 of mandrel 24.

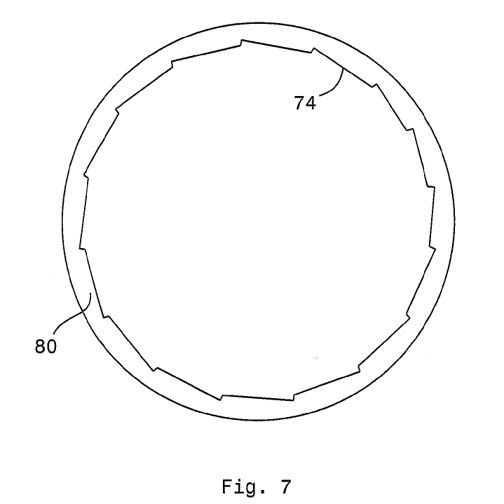

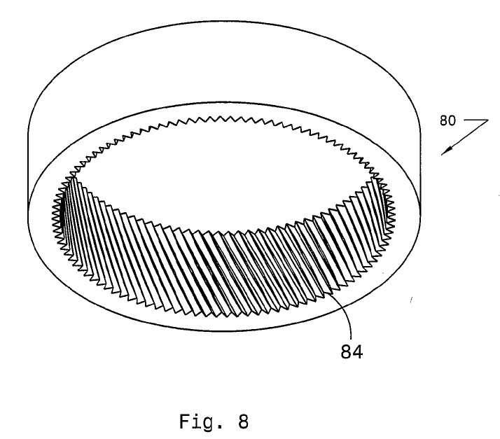

FIG. 7 illustrates the race 82 of a one-way clutch that includes ramp cam surfaces 74, formed on the inner surface of the race. The cam surfaces 74 of the race 82 are engaged in service by an engagement element, such as a roller, sprag or ball, to produce a drive connection between an inner race and outer race of the clutch.

FIG. 8 illustrates a ring gear 80 for a planetary gearset of an automatic transmission that includes internal helical gear teeth 84.

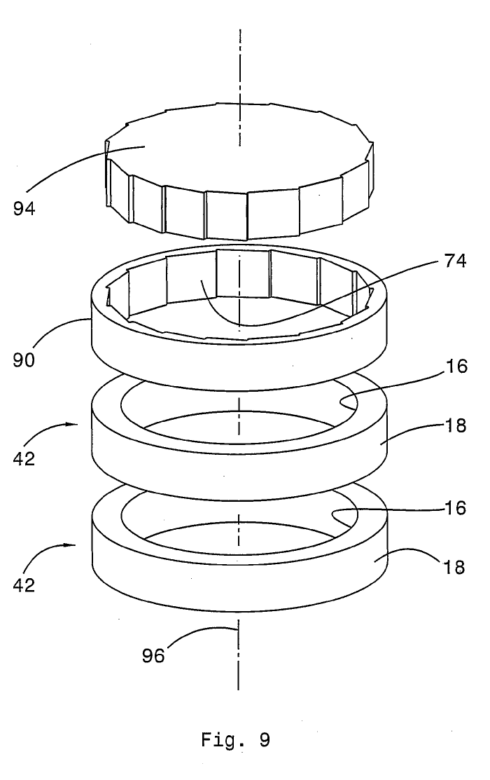

An alternate method for cold forming a clutch race 90 by extruding the cam surface net-shape in die tooling is described with reference to FIG. 9. The perform cylinder 40, 41 is flow formed and cut into segments 42 having a circular cylindrical inner surface 16 and outer surface 18, as described with reference to FIGS. 1-4 or FIGS. 5A-5D and 6. Preferably, the length of the preform cylinder 40, 41 is sufficient to produce about ten segments 42, from each of which clutch race 90 is to be formed.

Each circular cylindrical segment 42 is spheroidize annealed and coated with a standard phosphate/soap coating, which actions are conventional in metal forming operations.

As FIG. 9 illustrates, a segment 42 is placed in extrusion tooling against a precision ground forming mandrel 94, whose outer surface is formed with the negative of cam surfaces 74 to be formed on the inner surface of the clutch race 90. Standard hydraulic press equipment is used to force mandrel 94 along axis 96 into and through the cylindrical segment 42 to form the cam ramp surfaces 74 on the inner surface 16 of the segment.

After forming the cam ramp surfaces 74 on the inner surface of the segment 42, the outer surface 18 of the segment is ground to within a tight tolerance and the inner surface 16 has a series of cam ramp surfaces 74 arranged angularly about axis 96 and formed to near net shape. The clutch race 90 is thereafter finish machined, thermally processed and coated.

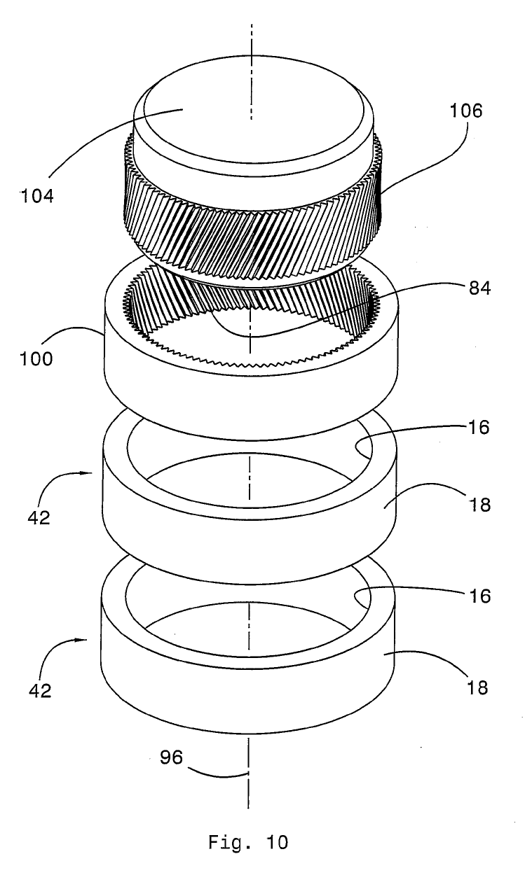

An alternate method for cold forming a ring gear 100 by extruding the gear teeth net-shape in die tooling is described with reference to FIG. 10. First the perform cylinder 40, 41 is formed and cut into segments 42 having a circular cylindrical inner surface 16 and outer surface 18, as described with reference to FIGS. 1-4 or FIGS. 5A-5D and 6. Preferably, the length of the preform cylinder 40, 41 is sufficient to produce about ten segments 42, from each of which a ring gear 100 is to be formed.

Each circular cylindrical segment 42 is spheroidize annealed and coated with a standard phosphate/soap coating, which actions are conventional in metal forming operations.

As FIG. 10 illustrates, a segment 42 is placed in extrusion tooling against a precision ground forming mandrel 104, whose outer surface is formed with the negative of helical gear teeth 84 to be formed on the inner surface of the ring gear 100. Standard hydraulic press equipment of the type described in U.S. Pat. No. 5,465,597, the entire disclosure of which is incorporated herein by reference, is used to force the mandrel 104 along axis 96 into and through the cylindrical segment 42 to form the gear teeth 106 on the inner surface 16 of the segment 42.

After forming the gear teeth 84 on the inner surface of the segment 42, the outer surface 18 of the segment is ground to within a tight tolerance and the inner surface has a gear teeth arranged angularly about central axis 96 and formed to near net shape. The ring gear 100 is thereafter finish machined, thermally processed and coated.

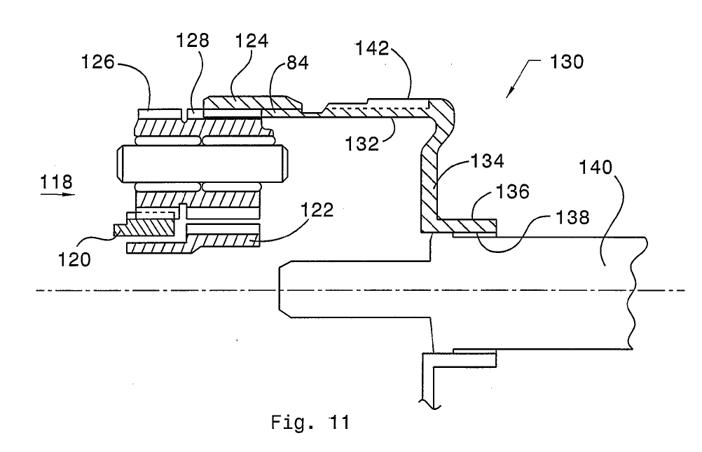

Referring to FIG. 11, a portion of the kinematic arrangement of an automatic transmission for a rear wheel drive motor vehicle include a Ravigneaux gear set 118, whose components include a first sun gear 120, a second sun gear 122, a ring gear 124, and two sets of planetary pinions 126, 128. The pinions of the first set 126 mesh with first sun gear 120 and ring gear 124; the pinions of the second set 128 mesh with second sun gear 122 and the pinions of the first set 126.

Transmission output torque is transmitted to the transmission output shaft 140 by a ring gear-brake drum 130, which is formed integrally, i.e., in one component without need for bonding, welding or a mechanical connection between or among components. The ring gear-brake drum 130 includes the ring gear 124, a park brake drum 132, a radial disc 134, and a sleeve hub 136. Transmission output torque carried by the ring gear 124 is transmitted axially by the park brake drum 132 to the radial disc 134, which carries the torque to the sleeve hub 136, which is connected by a spline 138 to the transmission output shaft 140. The ring gear 124 is formed with internal, helical gear teeth 84. The parking drum 132 is formed with external teeth 142, which are engaged by a park pawl, secured to the transmission case for preventing the vehicle from moving inadvertently when the wheel brakes are disengaged.

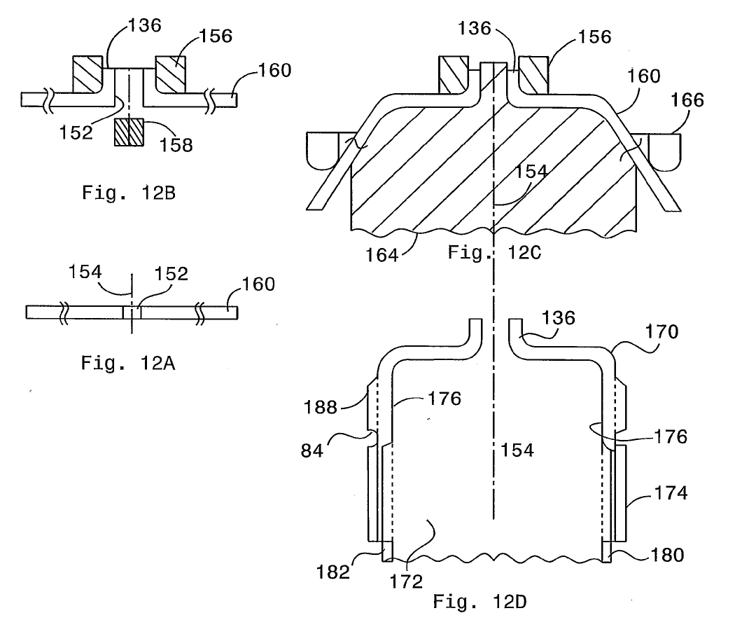

To avoid the necessity of producing and interconnecting multiple separate components, the integrated ring gear-park brake drum 130 is produced, as described with reference to FIGS. 12A-12F, by first stamping a flat, circular steel plate or section of round bar stock 150 formed with a hole 152 concentric with an axis 154.

The hub portion 136 is formed by extruding or drawing the central portion of plate 50 through an external die 156 and passing an internal die 158 through hole 152, thereby cold forming the preform 160 shown in FIG. 12 to a final net shape internal diameter 162 for hub 136. The perform 156 is sphereoidize annealed and coated for extrusion forming.

Preform 160 is cold formed progressively in successive steps to the shapes shown in FIGS. 12C and 12D by inserting a series of internal dies 164 into preform 160 and passing a series of draw rings 166 over the preform 160 until the preform acquires the shape of a circular cylindrical preform 170 having a substantially uniform wall thickness. Alternately, preform 160 may be flow formed from the intermediate shape shown in FIG. 12C on an internal forming mandrel using rollers 30 until preform 160 acquires the shape of the cylindrical preform 170 shown in FIG. 12D.

When preform 160 is formed into the shape of a cylindrical preform 170, either with walls of uniform or varied thickness, dies 158 and 164 are removed from the preform and a flow forming mandrel 172 is inserted into the cylindrical preform. The tailstock 28 is used to clamp preform 170 to the mandrel 172. Then rollers 30 are forced into contact with the outer surface 174 of preform 170. Each roller 30 rotates about its respective axis 34 and translates along axis 154.

The outer surface 174 is flow formed by contact pressure between preform 170 and rollers 30 and by movement of the rollers over the preform.

The inner surface 176 of preform 170 is flow formed due to contact pressure between preform 170 and mandrel 172, which contact pressure forces the preform into contact with the outer surface 180 of mandrel 172.

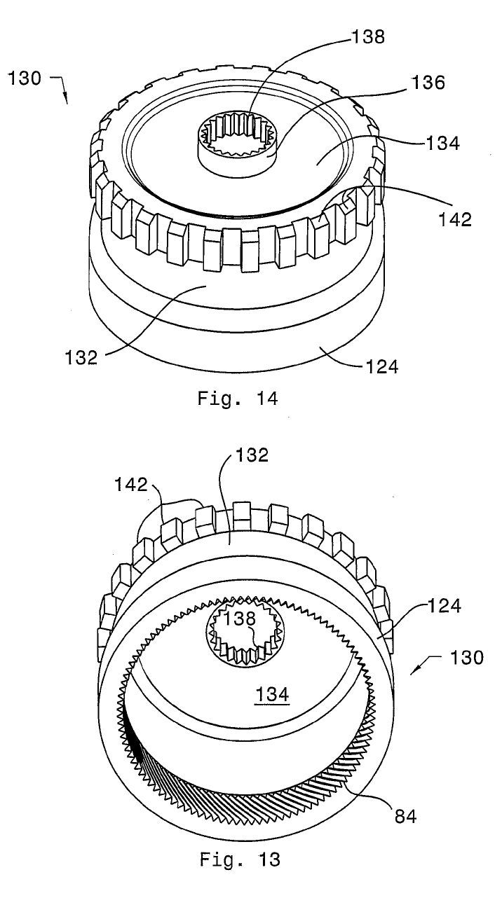

The outer surface 180 of mandrel 172 is formed with external gear teeth 182. In this way, helical gear teeth 84, shown in FIG. 13, are formed on the inner surface of the ring gear 124 portion of the ring gear-brake drum 130.

In a separate operation, the cup shaped preform is spheroidize annealed and coated with conventional forming materials, then a precision mandrel is used to back extrude helical gear teeth into the workpiece using a hydraulic press and specialized tooling. In this way, helical gear teeth 84, shown in FIG. 13, are formed on the inner surface of the ring gear 124 portion of the ring gear-brake drum 130.

The park brake teeth 142 are cold formed or hob cut on the outer surface 188 of the drum portion 132, where its wall thickness is increased along a length of the drum portion as shown in FIGS. 12D and 14.

Spline 138 is broached on the inner surface of the hub 136, thereby forming a drive connection that is engaged with a spline on the outer surface of the output shaft 140.

Finally, the integrated ring gear-park brake drum 130 is heat treated.

In accordance with the provisions of the patent statutes, the preferred embodiment has been described. However, it should be noted that the alternate embodiments can be practiced otherwise than as specifically illustrated and described.

The invention claimed is:

1. A component for transmitting torque between a gear unit and a shaft, comprising:
a ring gear portion;
a park brake drum portion formed integrally with the ring gear portion;
a disc portion formed integrally with the park brake drum portion; and
a hub portion formed integrally with the disc portion.

2. The component of claim 1, wherein the ring gear includes internal helical gear teeth.

3. The component of claim 1, wherein the hub portion includes spline teeth directed axially along an axis and located on an inner surface of the hub portion facing the axis.

4. The component of claim 1, wherein the park brake drum portion includes series of park brake teeth extending along an axis at an axial end of the park brake drum portion.

5. The component of claim 1, wherein the park brake drum portion includes series of park brake teeth extending radially from an outer surface.

6. The component of claim 1, wherein a hub portion includes spline teeth directed axially along an axis and located on an outer surface of the hub portion facing away from the axis.

7. A component for transmitting torque between a planetary gear unit and a shaft, comprising:
a park brake drum portion including, a surface that extends along an axis, and a series of park brake teeth mutually spaced about the axis and located on the surface;
a disc portion formed integrally with the park brake drum portion and extending toward the axis; and
a hub portion formed integrally with the disc portion, including a hollow cylinder that extends along the axis and spline teeth formed on the hollow cylinder.

8. The component of claim 7, wherein the spline teeth are directed axially along the axis and are located on an inner surface of the hub portion facing the axis.

9. The component of claim 7, wherein the park brake teeth are located at an axial end of the park brake drum portion.

10. The component of claim 7, wherein the park brake teeth extend radially from an outer surface of the park brake drum portion.

11. The component of claim 7, wherein spline teeth are directed axially along the axis and are located on an outer surface of the hub portion facing away from the axis.

12. A component for transmitting torque between a planetary gear unit and a shaft, comprising:
a ring gear portion including an inner surface formed with gear teeth that extend angularly about and along an axis;
a drum portion formed integrally with the ring gear portion and including a surface that extends along the axis;
a disc portion formed integrally with the drum portion and extending toward the axis; and
a hub portion formed integrally with the disc portion, the hub portion including a hollow cylinder that extends along the axis and spline teeth.

13. The component of claim 12, wherein the gear teeth are internal helical gear teeth.

14. The component of claim 12, wherein the spline teeth are directed axially along the axis and are located on an inner surface of the hub portion facing the axis.

15. The component of claim 12, wherein spline teeth are directed axially along the axis and are located on an outer surface of the hub portion facing away from the axis.
